(19) United States
(12) Patent Application Publication
(10) Pub. No.: US 2015/0138539 A1
(43) Pub. Date: May 21, 2015

(54) METHOD OF ESTIMATING A REFLECTION PROFILE OF AN OPTICAL CHANNEL

(71) Applicant: ALCATEL LUCENT, Boulogne-Billancourt (FR)

(72) Inventors: Stijn Meersman, Antwerp (BE); Rudi Vankeirsbilck, Antwerp (BE); Michael Straub, Stuttgart (DE); Joerg Hehmann, Stuttgart (DE); Yannick Clybouw, Gent (BE)

(21) Appl. No.: 14/400,935

(22) PCT Filed: Apr. 30, 2013
(86) PCT No.: PCT/EP2013/058956

§ 371 Date: Nov. 13, 2014

(30) Foreign Application Priority Data
Jun. 14, 2012 (EP) 12305674.9

(51) Int. Cl. G01M 11/00

(52) U.S. Cl. CPC G01M 11/3145
USPC 356/73.1

(57) ABSTRACT

Proposed is a method of estimating a reflection profile of an optical channel. The method comprises different steps. A measured reflection profile of the optical channel is provided. One or more reflection peaks are estimated within the measured reflection profile. A residual reflection profile is determined, by removing the estimated reflection peaks from the measured reflection profile. Furthermore, a modified residual reflection profile is determined, by modifying one or more estimated crosstalk frequency components within the residual reflection profile. Finally, the estimated reflection profile is determined, by superposing the estimated reflection peaks and the modified residual reflection profile.

### FIELD OF THE INVENTION

The invention relates to a method of and a device for estimating a reflection profile of an optical channel.

### BACKGROUND

These days, access networks, also called passive optical networks (PON), are used for connecting a plurality of customers to a core network of data transportation.

In such an access network, the interconnection between the core network and the access network is given at a so-called central office, which contains an optical line terminal (OLT).

The OLT is connected via at least one optical fiber, preferably called optical feeder fiber, to a so-called remote node. At this remote node, an optical downlink signal transmitted by the OLT is split onto different optical branches, to which one or more customers are connected by means of optical network units (ONU).

The customers send via the optical branches optical uplink signals towards the remote node, which combines these optical uplink signals to a combined uplink signal and transmits the combined signal via the optical feeder fiber to the central office, which contains the OLT.

In order to determine the transmission properties of the transmission channel into which a device transmits an optical signal, a measurement technique of optical time domain reflectometry (OTDR) can be applied. In such an OTDR measurement, a reflection profile of the transmission channel is estimated. Preferably, the technique of OTDR is carried out at the OLT.

For the purpose of OTDR, an optical measurement signal in the form of an optical pulse may be transmitted into the optical channel, which comprises one or more optical fibers. Such Optical fibers are usually made of inhomogeneous material, which causes backscattering of the optical measurement signal. The backscattered optical signal, preferably called received response signal, may then be recorded over time as the reflection profile. Knowing the propagation speed of the optical signals within the optical fibers, the received response signal can be converted from the time domain to a distance.

Different imperfections of the optical channel, such as e.g. an open connector or a dirty fiber-connector, may cause characteristic increased or decreased backscattering of the measurement signal, which in turn may be observed as reflection peaks within the reflection profile. By examining the reflection profile and the reflection peaks contained in the profile, one may derive, at which distance an imperfection is present within the optical channel.

Instead of using a single optical pulse as the measurement signal, a more advanced technique of OTDR may be employed. This advanced technique makes use of an optical signal that is modulated in its amplitude in dependence on a correlation sequence. The received response signal is first recorded and then used for determining the reflection profile. This is achieved, by correlating a time-discrete version of the received response signal with the initial correlation sequence itself. In the case, that the auto-correlation function of the correlation sequence is equal to or approximated by the dirac delta function, the result of the correlation yields an estimate of the impulse response of the optical channel in the time domain, which is an approximation of the reflection profile.

When transmitting an optical transmission signal carrying transmission data into the optical channel using a transmission device, it is one possibility to carry out the technique of OTDR, by using a further, separate device. The transmission device and the separate OTDR device are in this case both coupled to the same optical channel, preferably via an optical coupler.

A more advanced technique is that of embedded OTDR (eOTDR), in which the transmission device itself contains the hardware for generating the optical transmission signal as well as the hardware that is necessary for carrying out an OTDR measurement. Preferably, the optical transmission signal is directly modulated in dependence on a correlation sequence, wherein the frequency of this direct modulation is chosen, such that it does not disturb data reception at a receiving side. After transmitting into the optical channel the optical transmission signal, which carries the directly modulated measurement signal, the received response signal of the optical channel can be obtained, by filtering out that frequency, at which the optical transmission signal was modulated. This received response signal can then be used for determining a reflection profile via the technique of signal correlation as it has been described previously above.

### SUMMARY

Proposed is a method of estimating a reflection profile of an optical channel. The method comprises different steps.

A measured reflection profile of the optical channel is provided. One or more reflection peaks are estimated within the measured reflection profile.

A residual reflection profile is determined, by removing the estimated reflection peaks from the measured reflection profile. Furthermore, a modified residual reflection profile is determined, by modifying one or more estimated crosstalk frequency components within the residual reflection profile.

Finally, the estimated reflection profile is determined, by superposing the estimated reflection peaks and the modified residual reflection profile.

In order to grasp the advantages of the proposed method, the following aspects may be taken into consideration.

When carrying out a method of embedded OTDR, the hardware components carrying out the measurement of the reflection profile may experience an impact of crosstalk noise caused by other hardware components present within one same device. Such crosstalk noise may degrade the measured response signal and thus also the measured reflection profile. Crosstalk noise may be present especially, in the case that the integration of the OTDR devices into the transmission device is given as a Small Form-Factor Pluggable (SFP).

For obtaining a reliable estimated reflection profile, the impact of crosstalk noise needs to be reduced. One countermeasure may be, to shield the hardware devices, in order to reduce the amount crosstalk noise caused by electromagnetic fields generated by the hardware devices. Such a countermeasure is on the one hand cumbersome and on the other hand may also be expensive, due to space restrictions given for a device carrying out eOTDR.

In order to remove the crosstalk noise from the measured reflection profile, filtering techniques may be applied. Such filtering techniques may not only have an impact on the crosstalk noise, but also on reflection peaks present within the measured reflection profile. As it has been previously described, such reflection peaks should remain present within a filtered reflection profile, in order to detect imperfections of the optical channel.

The proposed method first estimates the reflection peaks and then removes these peaks, in order to yield a residual reflection profile. Next, the residual reflection profile is filtered, such that estimated crosstalk frequency components are modified. Due to the fact, that crosstalk usually causes one or more spectral peaks within the spectrum of a reflection profile, the crosstalk noise may be reduced, by modifying the estimated crosstalk frequency components. After modifying the crosstalk frequency components, the yielded modified residual reflection profile is superposed with the previously estimated reflection peaks.

Thus, the proposed method of estimating a reflection applies a filtering technique, in which estimated reflection peaks are first separated from the measured reflection profile, before separately filtering the crosstalk noise in the frequency domain, and then finally superposing the filtering result with the preserved reflection peaks again. Thus, this filtering technique for reducing crosstalk impact avoids a severe degradation of the reflection peaks present within the finally estimated reflection profile. Therefore, the estimated reflection profile contains well preserved reflection peaks. Thus, the estimated reflection profile may be used for detecting imperfections of the optical channel via the reflection peaks, as well as reliably estimating the attenuation profile of the optical channel due to reduced crosstalk noise.

### BRIEF DESCRIPTION OF THE FIGURES

FIG. 1 shows a flowchart of the proposed method according to an embodiment.

FIGS. 2a and 2b show a measured reflection profile in the linear and the logarithmic domain.

FIG. 3 shows a second derivative of the measured reflection profile in the linear domain.

FIG. 4a shows estimated reflection peaks.

FIG. 4b shows a residual reflection profile.

FIG. 5 shows a magnitude of a spectrum of the residual reflection profile.

FIG. 6 shows a first derivative of the magnitude.

FIG. 7 shows a modified residual reflection profile.

FIGS. 8a and 8b show an estimated reflection profile in the linear and the logarithmic domain, respectively, plotted over a time scale on the abcissa.

FIGS. 9a and 9b show the estimated reflection profile in the linear and the logarithmic domain, respectively, plotted over a distance scale on the abcissa.

FIG. 10 shows a proposed device according to an embodiment.

### DESCRIPTION OF EMBODIMENTS

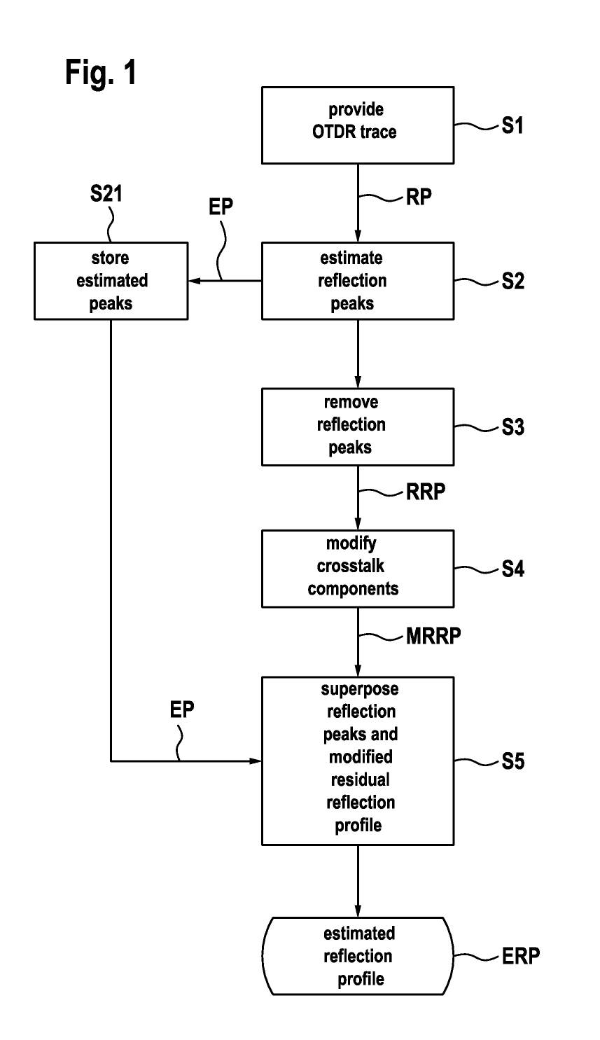

FIG. 1 shows a flowchart of the proposed method according to a preferred embodiment. In the step S1, an OTDR trace as a measured reflection profile of an optical channel is provided. This OTDR trace may be measured by a device carrying out also the proposed method. According to an alternative solution, the OTDR trace may be provided by a first device to a second device via a data interface of the second device, which receives the data of the OTDR trace, and which then provides the OTDR trace to further sub-devices of the second device carrying out the further steps of the proposed method.

The OTDR trace is preferably a measured reflection profile in the form of a time discrete sampled signal. Preferably, the sampling frequency of the sampled measured reflection profile lies within the range of several megahertz, preferably 40 MHz. Such a sampling frequency of 40 MHz corresponds to a sampling interval of 25 ns. Taking into consideration typical propagation speeds of optical signals within optical fibers, the sampling interval of 25 ns corresponds to a resolution in distance of 2.5 m.

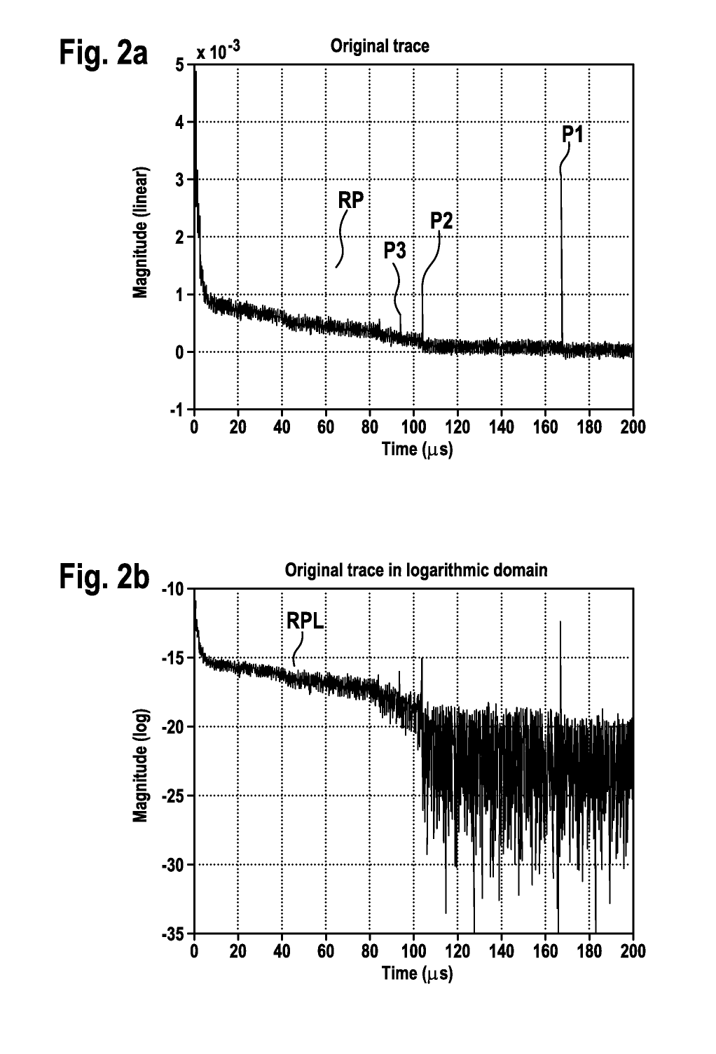

The measured reflection profile RP is provided to a next step S2 of the proposed method. FIG. 2a shows an example of a measured reflection profile RP in the linear domain, wherein a timescale corresponding to a time resolution in microseconds is shown along the abcissa. The reflection profile RP contains in this example at least three reflection peaks P1, P2, P3, as well as crosstalk noise, which is clearly visible as a noise signal overlaying the reflection profile RP.

The reflection profile RP of FIG. 2a is once more shown in FIG. 2b as a reflection profile RPL in the logarithmic domain. Both refection profiles RP and RPL of the FIGS. 2a and 2b are plotted here as time continuous signals over a time scale of microseconds, wherein a person skilled in the art will acknowledge, that such time continuous plots may represent time discrete and sampled reflection profiles. Thus, the plotted values of the reflection profiles RP and RPL can be considered as time discrete values plotted over discrete indices corresponding to the timescales shown in the FIGS. 2a and 2b.

Coming back to FIG. 1, reflection peaks EP present within the reflection profile RP are estimated within the step S2. These estimated reflection peaks EP may then be stored in a separate step S21. The measured reflection profile RP is provided in the time domain, while the estimated reflection peaks EP are preferably also estimated in the time domain. For estimating the reflection peaks, a second derivative of the measured reflection profile is determined. This may be obtained, by determining for the time discrete measured reflection profile the signal of second differential order in the time domain. Having yielded this second derivative, a reflection peak is estimated to be present for those time discrete indices, for which the second derivative exceeds a defined threshold.

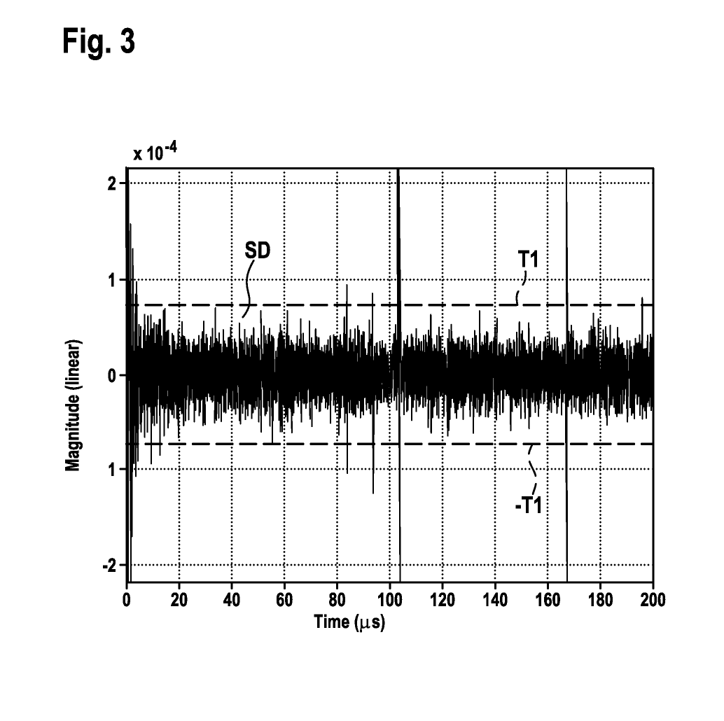

FIG. 3 shows the second derivative SD together with the threshold T1. The threshold T1 may be determined, by determining the median absolute value of the second derivative SD. Preferably, the threshold T1 is chosen to this median absolute value multiplied by a fixed factor. The fixed factor is preferably chosen within the range between the values 1 and 10. In a preferred embodiment, the fixed factor is chosen to the value 6.

As it was previously outlined, for estimating the presence of one or more reflection peaks, those time-discrete indices of the second derivative are determined, for which the second derivative exceeds the threshold. The estimated reflection peaks are then determined as those values of the measured reflection profile RP, whose time-discrete indices correspond to or are equal to the determined time-discrete indices.

Preferably, not only these determined values of the measured reflection profile RP are used as the estimated the reflection peaks and then removed, but also further values of the measured reflection profile RP are determined used as the estimated reflection peaks. These further values are those, whose corresponding further time-discrete indices lie within predefined time windows, which are centered around the previously determined time-discrete indices. Thus, preferably, a combined set of values corresponding to a combined set of time-discrete indices is used for estimating the reflection peaks, wherein the combined set of time-discrete indices is a combination of the previously determined set of time-discrete indices and the further time-discrete indices.

For a sampling frequency of 40 MHz for the measured reflection profile RP, a time window has preferably a width of 8 time discrete indices, which corresponds to 200 ns or a distance resolution of 20 m. Furthermore, the timely width of the time window corresponds to a full-width-at-half-maximum of an optical pulse, when using only a single optical pulse for OTDR measurement instead of a correlation sequence. Even furthermore, the timely width of the time window corresponds to a timely width of a dirac-delta function resulting from OTDR measurement using a correlation sequence.

The time window is preferably a weighting window, which defines weighting factors for the values of the measured reflection profiles falling within the time window. According to a first solution, the weighting window is a simple boxcar window applying a constant factor of 1 to those value of the measured reflection profile, which fall within the time window. According to another solution, the weighting window is a raised cosine window, which applies different values within the range 0 to 1 to those values of the measured reflection profile, which fall within the time window. By using such a raised cosine window, a more smooth transition of values representing a reflection peak and values representing no reflection peak is achieved.

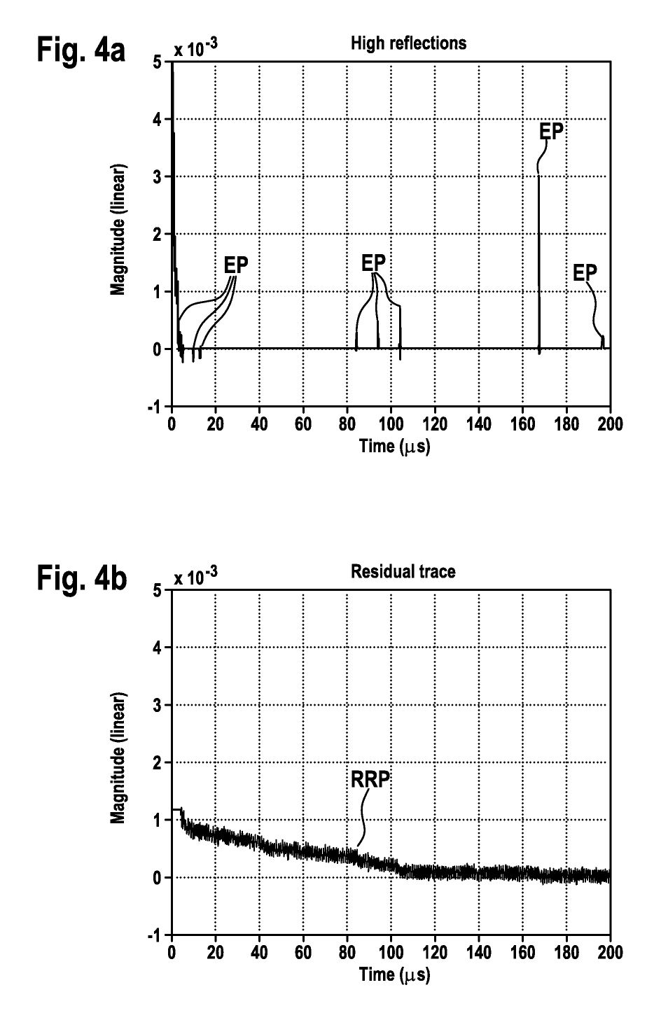

FIG. 4a shows a number of estimated reflection peaks EP in the linear domain.

Coming back to FIG. 1, the estimated reflection peaks are removed from the measured reflection profile RP within a step S3. This yields a residual reflection profile RRP. FIG. 4b shows the residual reflection profile RRP in the linear domain. The reflection peaks are removed from the residual reflection profile RRP, by replacing the initial values of the measured reflection profile at those indices, at which reflection peaks were detected, by the mean value of the reflection profile of those indices, which are adjacent to the indices at which reflection peaks were detected.

Coming back to FIG. 1, the obtained residual reflection profile RRP is then used for filtering out the crosstalk noise.

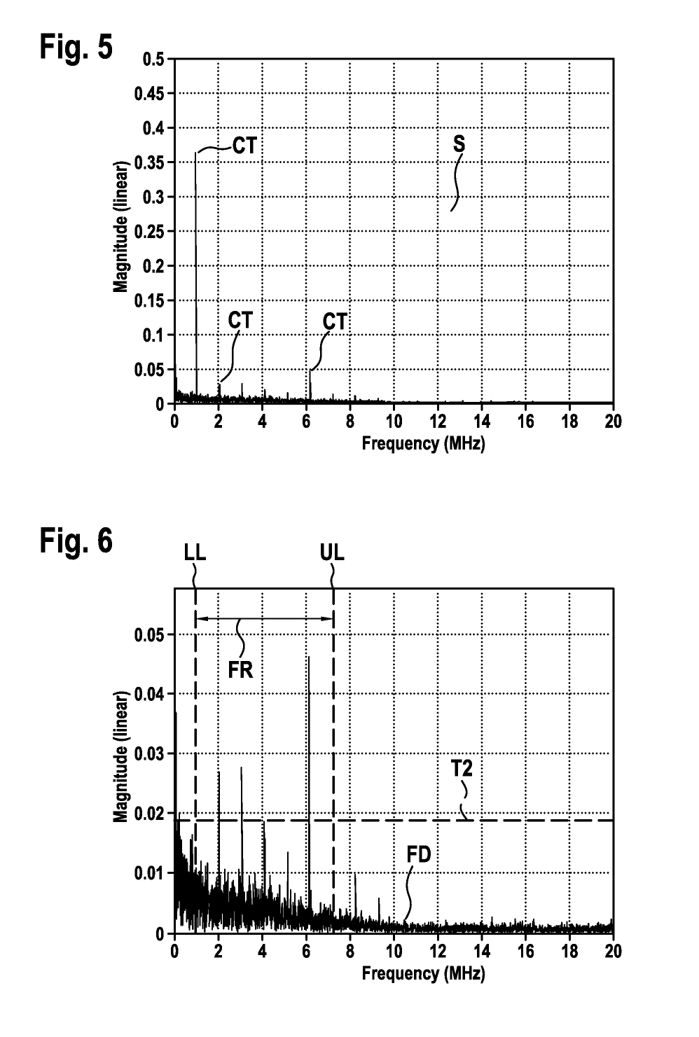

FIG. 5 shows a magnitude S of a spectrum of a residual reflection profile. Frequency components CT of the crosstalk noise are also indicated in FIG. 5. A modified residual reflection profile is determined, by modifying estimated crosstalk frequency components within the residual reflection profile's spectrum.

Such modification is carried out in the step S4 of the FIG. 1. The crosstalk frequency components CT shown in FIG. 5 are estimated in the frequency domain and also modified in the frequency domain. Such crosstalk frequency components CT can be expected as spectral peaks within the lower frequency domain, while normally no discontinuities are expected for higher frequencies within the residual reflection profile's spectrum.

For estimating the crosstalk frequency components CT, the spectrum of the reflection profile is determined, by transforming the residual reflection profile from the time domain to the frequency domain. This is preferably carried out by a frequency transformation, which is discrete in the time domain and discrete in the frequency domain. Preferably, the Fast Fourier Transform (FFT) is used. This yields a complex discrete frequency spectrum. The magnitude S of such a discrete frequency spectrum is the one shown in FIG. 5, wherein the frequency scale as a continuous scale is plotted along the abscissa. In this example, the number of discrete values plotted is 4096.

For finally detecting the crosstalk frequency components CT, the complex discrete frequency spectrum is differentiated once, preferably by determining the first order differential signal. This yields a complex first derivative. Then, the magnitude of this first derivative is determined, which yields real values.

FIG. 6 shows the magnitude FD of the first derivative of the residual reflection profile's spectrum. Those spectral indices of the first derivative's magnitude FD are determined, for which the first derivative's magnitude FD exceeds a spectral threshold T2. The complex spectrum is then modified in its complex values at those indices, which correspond to the determined spectral indices.

The threshold T2 may be determined, by determining a median value of the first derivative's magnitude FD. Preferably, the threshold T2 is chosen to this median value multiplied by a fixed factor. The fixed factor is preferably chosen within the range between the values 1 and 10. In a preferred embodiment, the fixed factor is chosen to the value 6.

Preferably, the threshold T2 is determined, by determining a median value of the first derivative's magnitude FD within a predefined spectral range FR. This spectral range FR has a lower frequency limit LL and an upper frequency limit UL. This median value may then be multiplied by a fixed factor. The fixed factor is preferably chosen within the range between the values 1 and 10. In a preferred embodiment, the fixed factor is chosen to the value 6.

Preferably, the modification of the complex spectral values of the spectrum is carried out not only for the spectral values at those spectral indices, for which the first derivative's magnitude FD exceeds the spectral threshold T2, but also for further values of the spectrum, whose further spectral indices lie within one or more predefined spectral windows, which are centered around the previously determined spectral indices.

Thus, preferably, a combined set of values corresponding to a combined set of discrete spectral indices is used for estimating the crosstalk frequency components and then modifying these components, wherein the combined set of discrete spectral indices is a combination of the previously determined set of discrete spectral indices and the further discrete spectral indices.

Preferably, the spectral window has a predefined width, which is preferably of a width of eight spectral indices. Preferably, this spectral window is a weighting window, which may in one alternative solution be a boxcar window applying weighting factors of 1 or 0. According to an alternative solution, the spectral window is a raised cosine window applying varying weighting factors within the range between 0 and 1.

The corresponding complex spectral values, which correspond to the spectral indices used for estimating the crosstalk frequency components, are modified to a respective mean value. For one of these corresponding complex spectral values, the respective complex mean value is determined as the mean of the adjacent spectral values, which are adjacent to the corresponding values to be modified.

Preferably, the estimation of the crosstalk frequency components and the modification of these components is limited to the predefined frequency range FR.

The modified complex spectrum is then transformed back from the frequency domain to the time domain, using preferably a time discrete and discrete frequency transform as an inverse transform. This inverse transform is preferably the inversed Fast Fourier Transform (IFFT).

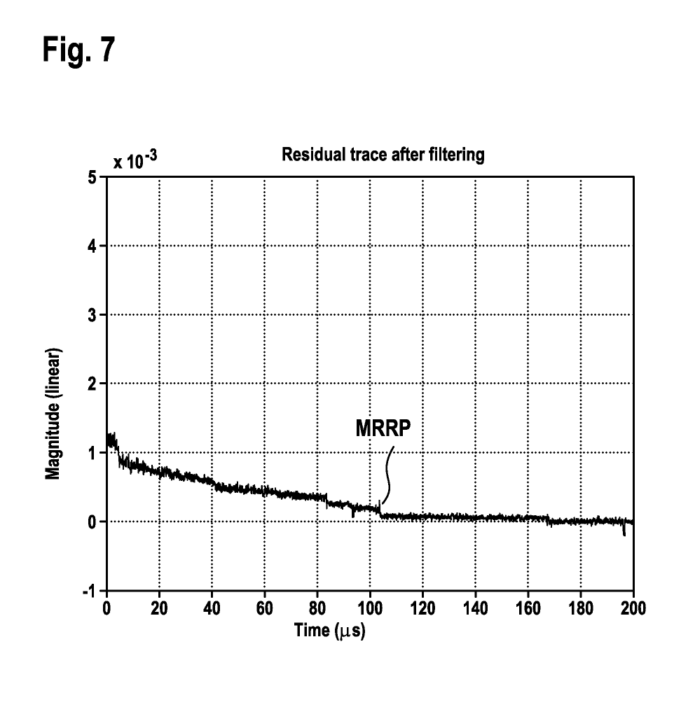

An obtained modified residual reflection profile is then provided from the step S4 to the step S5, as shown in FIG. 1. Such an example of a modified residual reflection profile MRRP is shown in FIG. 7 in the linear domain. As shown in FIG. 1, the yielded modified residual reflection profile MRRP is then superposed with the previously estimated reflection peaks EP within a step S5. This yields an estimated reflection profile ERP.

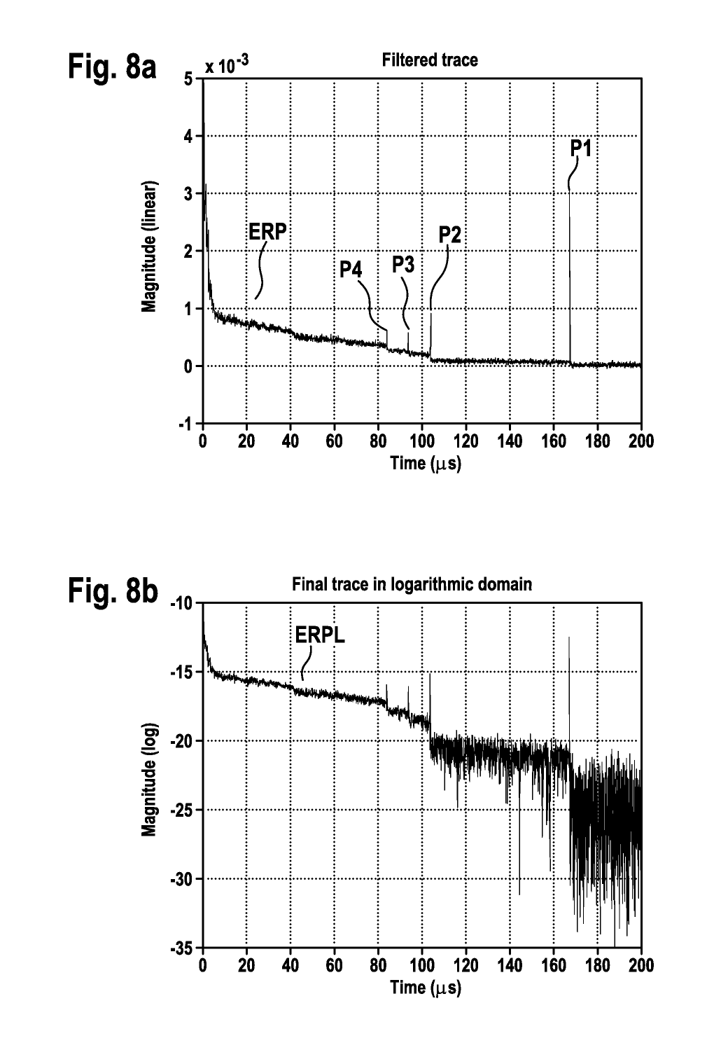

FIGS. 8a and 8b show an estimated reflection profile in the linear domain ERP as well as in the logarithmic domain ERPL, wherein these profiles are plotted over a time scale on the abcissa. By comparing the initially measured reflection profile RP of FIG. 2a with the estimated reflection profile ERP of FIG. 8a in the linear domain, it has to be noted, that the amount of crosstalk noise is reduced, while the impact of the step of reducing the crosstalk noise onto the reflection peaks is kept to a minimised amount. Looking at FIG. 8a, one can clearly see that not only the initially visible reflection peaks P1, P2 and P3 can be observed, but also the reflection peak P4, which was previously not easily visible within the reflection profile RP of FIG. 2a.

The proposed method is of advantage, since it first separates the estimated reflection peaks from the measured reflection profile, before then filtering the residual reflection profile, for reducing the amount of crosstalk noise. Furthermore, by later on superposing the estimated reflection peaks with the modified residual reflection profile, an estimated reflection profile is obtained, in which both aims, reducing crosstalk noise and preserving reflection peaks, is achieved.

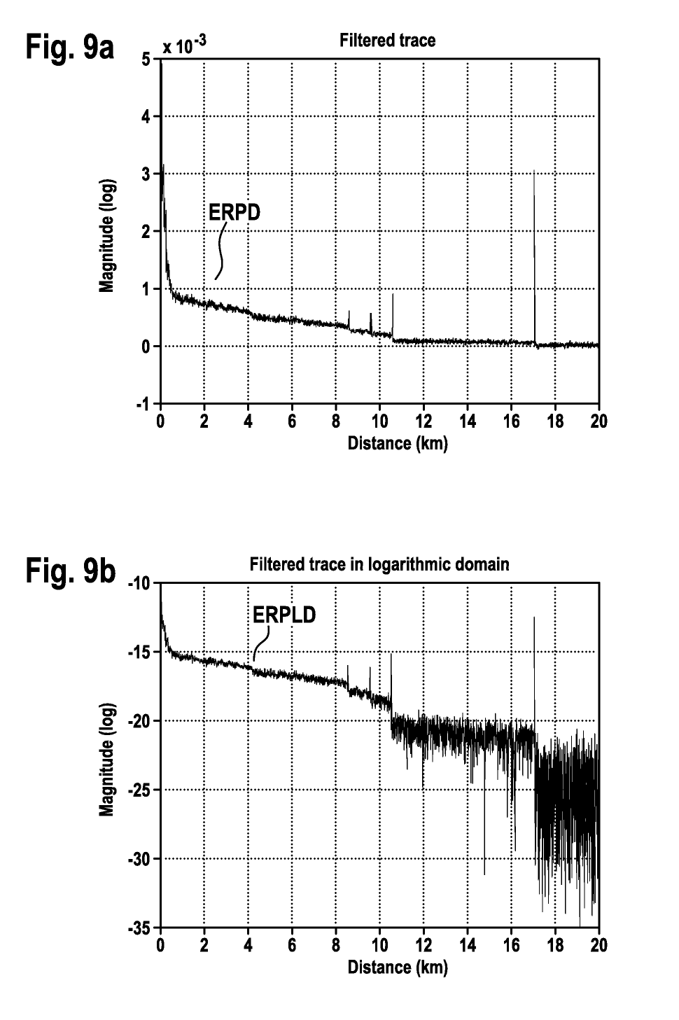

FIGS. 9a and 9b show an estimated reflection profile in the linear domain ERPD and in the logarithmic domain ERPDL, respectively, wherein these profiles are plotted over a distance scale on the abcissa.

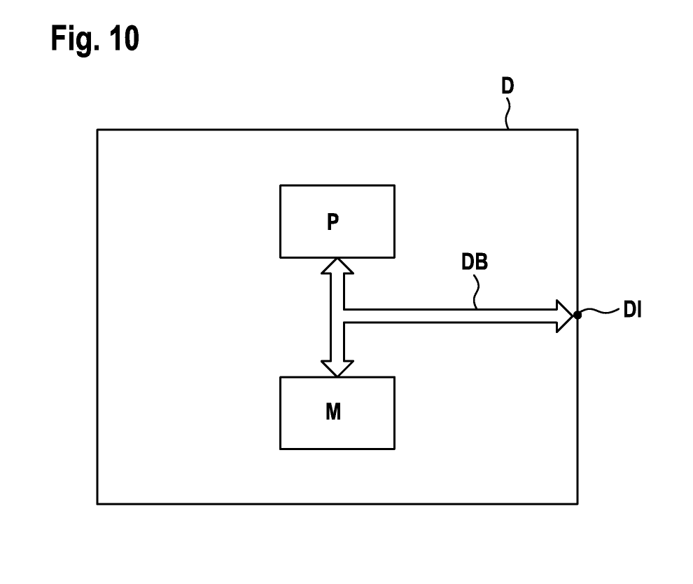

FIG. 10 shows the proposed device for estimating a reflection profile of an optical channel according to a preferred embodiment.

The device D contains a data interface DI, over which data representing a measured reflection profile can be received.

Preferably, the data interface DI is connected via a data bus DB to a processing device P as well as a memory device M.

The memory device M and the processing device P are operable, such that they jointly carry out the different steps of the proposed method described in detail above.

Thus, the memory device M and the processing device P are operable, to jointly estimate reflection peaks within a measured reflection profile, and furthermore to determine a residual reflection profile, by removing the estimated reflection peaks from the measured reflection profile.

Furthermore, the devices P and M are operable to jointly modify estimated crosstalk frequency components within the residual reflection profile, for determining a modified residual reflection profile. Finally, the devices P and M are operable, to jointly superpose the estimated reflection peaks and the modified residual reflection profile, for determining the estimated reflection profile.

The functions of the various elements shown in FIG. 10, including any functional block labelled as ‘processor’, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term ‘processor’ or should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

It should be appreciated by those skilled in the art that any block diagrams herein represent conceptual views of illustrative circuitry embodying the principles of the invention. Similarly, it will be appreciated that any flow charts may be substantially represented in computer readable medium and so executed by a computer or processor, whether or not such computer or processor is explicitly shown.

1) Method of estimating a reflection profile of an optical channel,
comprising
providing a measured reflection profile of said optical channel,
estimating one or more estimated reflection peaks within said measured reflection profile,
determining a residual reflection profile, by removing the estimated reflection peaks from said measured reflection profile,
determining a modified residual reflection profile, by modifying one or more estimated crosstalk frequency components within said residual reflection profile,
determining the estimated reflection profile, by superposing said estimated reflection peaks and said modified residual reflection profile.

2) Method according to claim 1,
wherein said measured reflection profile is provided in the time domain,
comprising furthermore
estimating said reflection peaks in the time domain,
removing said estimated reflection peaks in the time domain.

3) Method according to claim 2,
wherein the step of estimating said reflection peaks in the time domain includes
determining a second derivative of said measured reflection profile,
determining those indices of said second derivative, for which said second derivative exceeds a threshold.

4) Method according to claim 3,
wherein said step of estimating said reflection peaks in the time domain includes
using those values of said measured reflection profile, whose indices correspond to the determined indices.

5) Method according to claim 4,
wherein said step of estimating said reflection peaks in the time domain includes
using furthermore those values of said measured reflection profile, whose indices lie within one or more predefined time-windows centered around said determined indices.

6) Method according to claim 3,
wherein said threshold is determined, using a median absolute value of said second derivative.

7) Method according to claim 1,
wherein said measured reflection profile is provided in the time domain,
comprising furthermore
estimating said crosstalk frequency components in the frequency domain,
modifying said crosstalk frequency components in the frequency domain.

8) Method according to claim 7,
wherein the step of estimating said crosstalk frequency components in the frequency domain includes furthermore
determining a spectrum of said residual reflection profile, by transforming said residual reflection profile from the time domain to the frequency domain,
determining a first derivative of a magnitude of said spectrum,
determining those spectral indices of said first derivative, for which said first derivative exceeds a spectral threshold.

9) Method according to claim 8,
wherein the step of modifying said crosstalk frequency components in the frequency domain includes furthermore
modifying those values of said spectrum, whose spectral indices correspond to the determined spectral indices.

10) Method according to claim 9,
wherein the step of modifying said crosstalk frequency components in the frequency domain includes furthermore
modifying also those values of said spectrum, whose spectral indices lie within a one or more predefined spectral-windows centered around said determined spectral indices.

11) Method according to claim 10,
wherein the step of modifying said crosstalk frequency components in the frequency domain includes furthermore
setting spectral values within a respective spectral window to a respective mean value, wherein said mean value is determined as the mean of those spectral values, whose indices are adjacent to said respective spectral window.

12) Method according to claim 8,
wherein the step of determining said modified residual reflection profile includes furthermore
determining said modified residual reflection profile, by transforming the modified spectrum back to the time domain.

13) Device for estimating a reflection profile of an optical channel,
comprising
at least one data interface,
at least one memory device,
at least one processing device,
wherein said data interface is operable to receive a measured reflection profile of said optical channel,
and wherein said memory device ä
and said processing device are operable, to jointly
estimate one or more estimated reflection peaks within said measured reflection profile,
determine a residual reflection profile, by removing the estimated reflection peaks from said measured reflection profile,
determine a modified residual reflection profile, by modifying one or more estimated crosstalk frequency components within said residual reflection profile, and
determine the estimated reflection profile, by superposing said estimated reflection peaks and said modified residual reflection profile.
